(19) United States
(12) Patent Application Publication
(10) Pub. No.: US 2010/0326209 A1
(43) Pub. Date: Dec. 30, 2010

(54) APPARATUS AND METHOD FOR DETERMINING FORCES ACTING ON A VEHICLE IN A WIND TUNNEL

(76) Inventors: JOEL A. WALTER, Canton, MI (US); Leo Benetti-Longhini, Tullahoma, TN (US); Stephen A. Arnette, Murfreesboro, TN (US)

Correspondence Address: W. EDWARD RAMAGE, COMMERCE CENTER SUITE 1000, 211 COMMERCE ST, NASHVILLE, TN, 37201, US

(21) Appl. No.: 12/750,211

(22) Filed: Mar. 30, 2010

Related U.S. Application Data
(60) Provisional application No. 61/164,889, filed on Mar. 30, 2009.

(51) Int. Cl. G01M 9/00; G01L 1/00

(52) U.S. Cl. 73/862.541; 73/147

(57) ABSTRACT

A system for resolving the measured forces and moments at VRS attachment points and tire contact patches to a standard format for a wheeled vehicle in a windtunnel. The system reduces the data to arrive at the aerodynamic forces, moments and coefficients. The test vehicle is equipped with one or more wheel force transducers installed between the wheels and the corresponding hubs. A VRS rod or strut attaches to the wheel so that loads through the hub and into the wheel are sensed at both the VRS strut and the tire contact patch. The force transmitted through the hub into the wheel is sensed and measured directly by the wheel force transducer. The combination of measurements from the VRS load cells and the wheel transducers allows the determination of the external forces acting on the vehicle at the tire contact patch, which in turn leads to the aerodynamic forces acting on the vehicle. When combined with the geometry of the vehicle, the aerodynamic moments acting on the vehicle can then be determined.

This application claims benefit of and priority to U.S. Provisional Application Ser. No. 61/164,889, filed Mar. 30, 2009, and is entitled to that filing date for priority. The specification, FIGUREs and complete disclosure of U.S. Provisional Application Ser. No. 61/164,889 are incorporated herein by specific reference for all purposes.

### FIELD OF INVENTION

This invention relates to an apparatus and method for determining the forces acting on a vehicle, such as a ground vehicle, in a wind tunnel. More particularly, it relates to an apparatus and method for determining the aerodynamic forces by measuring all forces acting on vehicle restraint points and tire contact patches on a vehicle restrained to a moving ground plane in a wind tunnel.

### BACKGROUND OF THE INVENTION

A rolling wind tunnel is used to test the aerodynamic characteristics of vehicles, such as automobiles, at high speeds. The vehicle is held in place by a vehicle restraint system (VRS) on a rolling belt or road (i.e., a moving ground plane) in a contained area while subjected to high speed wind (i.e., a wind tunnel), which can exceed 180 mph. The moving ground plane moves at the same speed as the wind tunnel air. Temperature is controlled. Aerodynamic forces on the automobile are determined as the sum of all other measured forces. These measurements are of particular interest to motor sports teams and auto manufacturers.

### SUMMARY OF INVENTION

In various embodiments, the present invention comprises a system for resolving the measured forces and moments at the VRS attachment points and the tire contact patches to a standard format. The system reduces the data to arrive at the resultant aerodynamic forces, moments and aerodynamic coefficients.

The VRS may comprise multiple restraints. In one exemplary embodiment, the VRS comprises four restraints, each comprising a bi-axial load cell to measure the reaction force in the horizontal plane. The restraints may comprise rigid or semi-rigid struts or rods connected to the wheel hub, cables connected elsewhere on the body of the vehicle, or any combination thereof.

The combination of measurements from the VRS load cells and the wheel transducer load cells allows the determination of the external forces acting on the vehicle at the tire contact patch, which in turn leads to the aerodynamic forces acting on the vehicle. When combined with the geometry of the vehicle, the aerodynamic moments acting on the vehicle can then be determined. The method of the present invention is valid for determining aerodynamic forces in all three spatial directions (e.g., drag, side force, and lift), and for different vehicle connection methods and attachment points.

### DESCRIPTION OF THE DRAWINGS

FIG. 1 is a view of a system with wheel transducers in accordance with an exemplary embodiment of the present invention.

FIG. 2 is a top view of force measurement locations for a VRS.

FIG. 3 is a right and left side view of force measurement locations for a VRS.

FIG. 4 is a diagram of forces and moments resolved to the center of a vehicle at the ground plane.

### DETAILED DESCRIPTION OF EXEMPLARY EMBODIMENTS

In one exemplary embodiment, the present invention comprises a system that resolves the measured forces and moments at the VRS attachment points and the tire contact patches to a standard format. The system reduces the data to arrive at the aerodynamic forces, moments and coefficients. The VRS may comprise multiple restraints; in one embodiment, the VRS comprises four restraints, each comprising a bi-axial load cell to measure the reaction force in the horizontal plane. The restraints may comprise rigid or semi-rigid struts or rods connected to the wheel hub, cable connected elsewhere on the body of the vehicle, or any combination thereof.

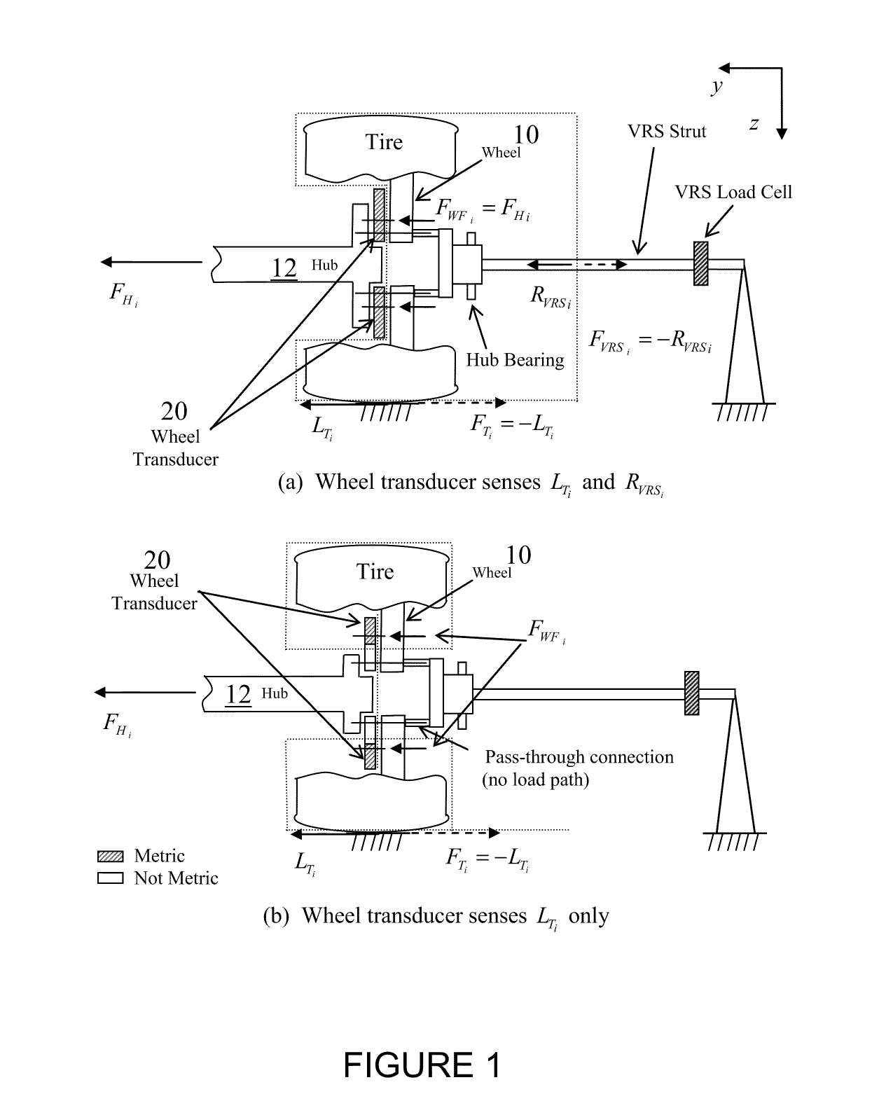

In one embodiment, the test vehicle is equipped with one or more wheel units with one or more wheel force transducers 20 installed between the wheel 10 and the hub 12, as shown in FIG. 1 (the view is a front view, with the center portion of the tire 8 cut away to show the transducer placement). The VRS strut attaches to the wheel so that loads through the hub and into the wheel are sensed at both the VRS strut and the tire contact patch. The force transmitted through the hub into the wheel (F_{WF}_{ᵢ}) is sensed and measured directly by the wheel force transducer(s) 20.

The combination of measurements from the VRS load cells and the wheel transducer load cells allows the determination of the external forces acting on the vehicle, including but not limited to the forces at the tire contact patches, which in turn leads to the aerodynamic forces acting on the vehicle. When combined with the geometry of the vehicle, the aerodynamic moments acting on the vehicle can then be determined. The method of the present invention is valid for determining aerodynamic forces in all three spatial directions (e.g., drag, side force, and lift), and for different vehicle connection methods and attachment points. The formulae and description of the calculations in the data reduction process are set forth below.

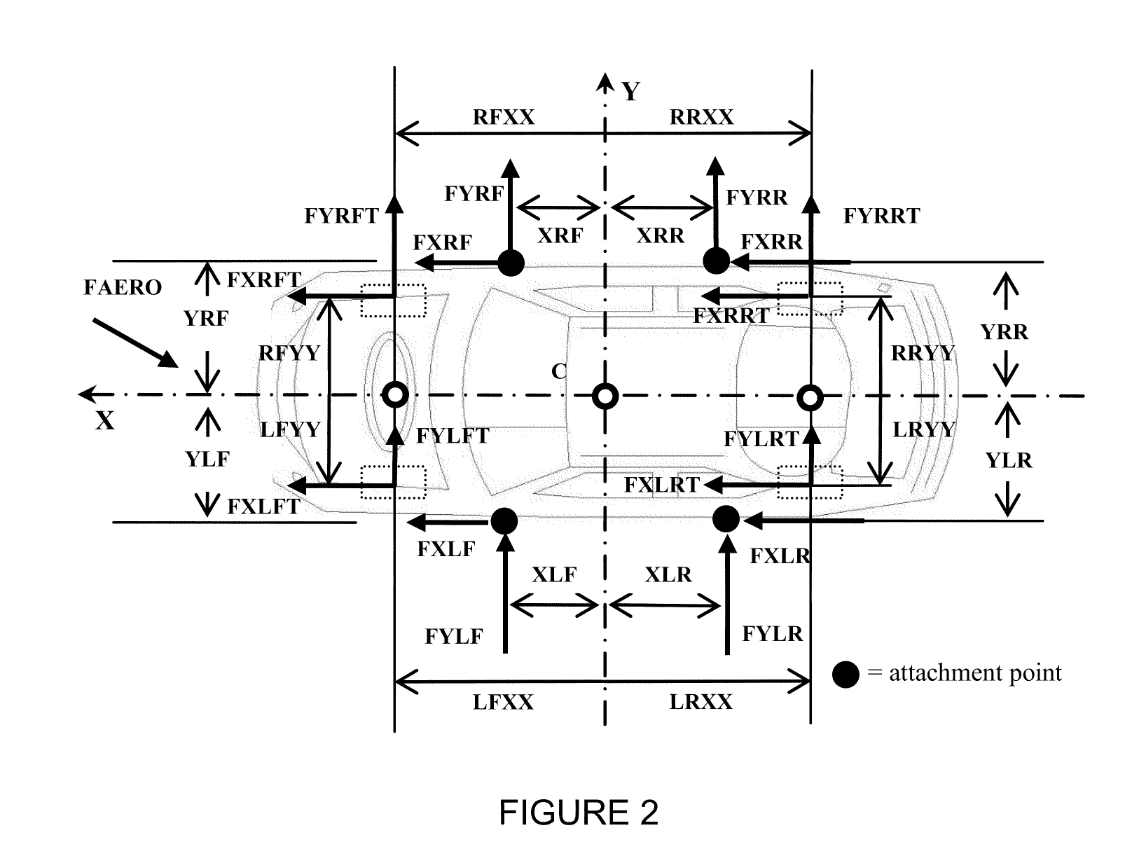

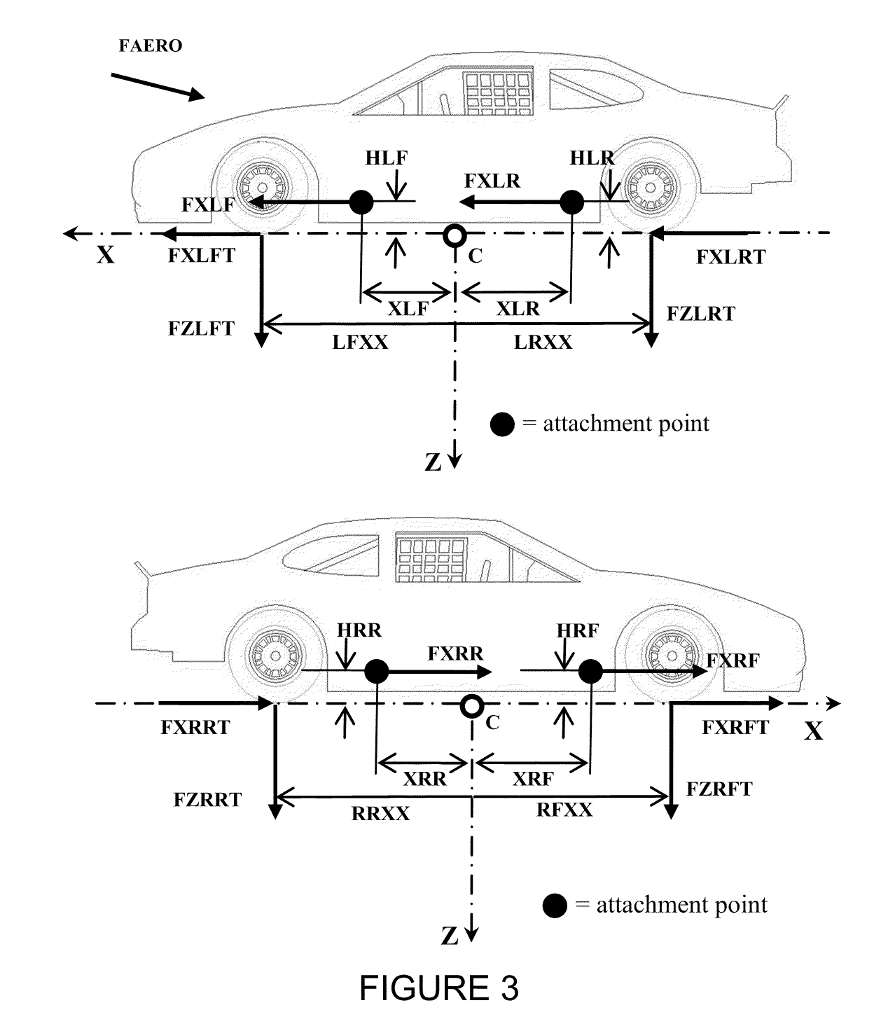

FIGS. 2 and 3 show all of the forces acting on a vehicle in a typical wind tunnel environment. The terminology used is as follows. “C” is the center of the wheelbase at the ground plane (i.e., track). “X”, “Y”, and “Z” are used to refer to the lateral, longitudinal and vertical directions, respectively. An initial “F” is used to refer to a force, “L” and “R” are used to refer to left and right sides, and “F” and “R” are used to refer to front and back. “T” refers to the tire contact patch. Thus, for example, FZLFT refers to the force acting vertically at the left front tire contact patch.

Distances to the VRS attachment points are considered scalar (positive) by convention. Thus, for example, XRF and XRR, the longitudinal distance from the extended center line to the right front attachment point and the right rear attachment points, respectively, are both positive. Measurements to the tire's center of pressure, by convention, have a sign associated with them. Thus, for example, RFXX, the distance from the extended center line to the right front tire center of pressure, is positive, while RRXX, the distance from the extended center line to the right rear tire center of pressure, is negative.

As shown, external forces include aerodynamic loading, gravity and resistance at the tire contact patches. Reactions to these external forces are measured at the VRS attachment points, as shown (e.g., FXRF, FYRF, FXRR, FYRR, FXLF, FYLF, FXLR, FYLR). Four VRS attachment points are shown in this example, but a different number of attachment points may be used, and for certain vehicle setups, fewer attachment points may, in fact, be desirable.

The aerodynamic and gravity forces act on the entire vehicle, while VRS reaction forces are point loads acting at each attachment point. In one embodiment, forces at the tire contact patch (FXRFT and FYRFT) also may be assumed to be point loads, acting at each tire's center of pressure.

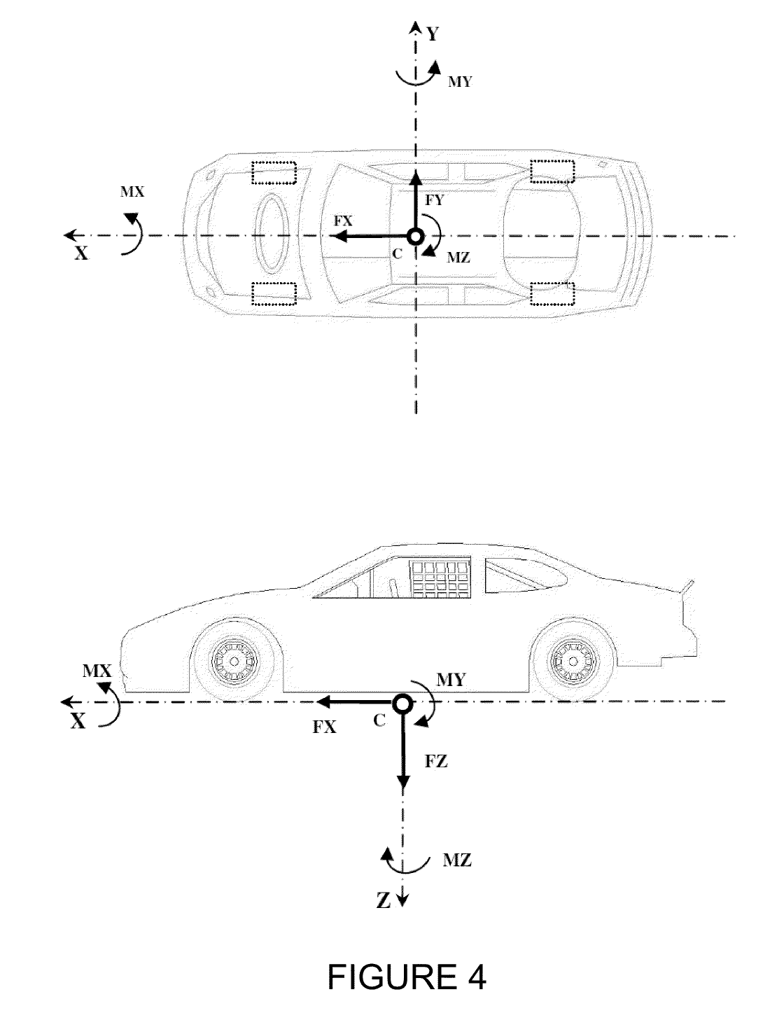

FIG. 4 shows the resolution of the forces and moments to the center of the wheelbase and track (point C). The net forces acting on the vehicle—aerodynamic forces, the reactions at the vehicle restraints, and the loads at the tire contact patches—must sum to zero:

Fₐₑᵣₒ+R_{VRS}+L_{T}=0

Fₐₑᵣₒ=−R_{VRS}−L_{T}

The net longitudinal aerodynamic force is:

FX=(FXLF+FXRF+FXLR+FXRR)+(FXLFT+FXRFT+FXLRT+FXRRT)

The net lateral aerodynamic force is:

FY=(FYLF+FYRF+FYLR+FYRR)+(FYLFT+FYRFT+FYLRT+FYRRT)

The net vertical force (aerodynamic and gravity) is:

FZ=FZLFT+FZRFT+FZLRT+FZRRT

The VRS and wheel transducer load cells do not measure the reaction forces at their restraint locations, but rather the forces of the vehicle on its surrounding environment. Therefore, these forces (FXLF, FYLF, FZLF, etc.) are opposite in sign to the actual reaction forces.

Each vector in FIGS. 2 and 3 can be moved from its point of action to point C without modifying its magnitude, so these net forces can be considered to act at point C. However, a corresponding couple moment about point C must be added to account for the moment about C that the force induced at its original point of action. The general equation for couple moments is

M_{c}=r×F

where r is the position vector drawn from point C to the point where F acts. The eight couple moments, using the sign conventions noted above, can be calculated as follows:

### LFVR (Left Front Vehicle Restraint):

M_{LFV}=i(FYLF HLF)−j(FXLF HLF)+k(FYLF XLF+FXLF YLF)

### RFVR (Right Front Vehicle Restraint):

M_{RFV}=i(FYRF HRF)j(FXRF HRF)+k(FYRF XRF−FXRF YRF)

### LRVR (Left Rear Vehicle Restraint):

M_{LRV}=i(FYLR HLR)−j(FXLR HLR)+k(−FYLR XLR+FXLR YLR)

### RRVR (Right Rear Vehicle Restraint):

M_{RRV}=i(FYRR HRR)−j(FXRR HRR)+k(−FYRR XRR−FXRR YRR)

### LFTCP (Left Front Tire Contact Patch):

M_{LFT}=i(FZLFT LFYY)−j(FZLFT LFXX)+k(FYLFT LFXX−FXLFT LFYY)

### RFTCP (Right Front Tire Contact Patch):

M_{RFT}=i(FZRFT RFYY)−j(FZRFT RFXX)+k(FYRFT RFXX−FXRFT RFYY)

### LRTCP (Left Rear Tire Contact Patch):

M_{LRT}=i(FZLRT LRYY)−j(FZLRT LRXX)+k(FYLRT LRXX−FXLRT LRYY)

### RRTCP (Right Rear Tire Contact Patch):

M_{RRT}=i(FZRRT RRYY)−j(FZRRT RRXX)+k(FYRRT RRXX−FXRRT RRYY)

The moment components shown in FIG. 4 can now be calculated from the above couple moment equations:

MX=FYLF*HLF+FYRF*HRF+FYLR*HLR+FYRR*HRR+FZLFT*LFYY+FZRFT*RFYY+FZLRT*LRYY+FZRRT*RRYY

MY=−(FXLF*HLF+FXRF*HRF+FXLR*HLR+FXRR*HRR+FZLFT*LFXX+FZRFT*RFXX+FZLRT*LRXX+FZRRT*RRXX)

MZ=(FYLF*XLF+FXLF*YLF)+(FYRF*XRF−FXRF*YRF)+(−FYLR*XLR+FXLR*YLR)+(−FYRR*XRR−FXRR*YRR)+(FYLFT*LFXX−FXLFT*LFYY)+(FYRFT*RFXX−FXRFT*RFYY)+(FYLRT*LRXX−FXLRT*LRYY)+(FYRRT*RRXX−FXRRT*RRYY)

If all of the reaction tire contact patch forces in the longitudinal, lateral and vertical force equations above are measured, the only unknown forces acting on the vehicle are the aerodynamic force and gravity. A weight tare (which typically may be run at low belt speed) is subtracted from the wind-on vertical force measurement.

For the coordinate system shown in FIG. 4, drag (D), lift (L), side force (S), rolling moment (RM), pitching moment (PM), and yawing moment (YM) are defined as follows:

D=−FX

L=−FZ

S=FY

RM=MX

PM=MY

YM=MZ

These correspond to the aeronautical adage that “everything is positive in a climbing right-hand turn.” Beyond these definitions in the SAE standard, force couple methods similar to those described above can be used to determine the components of lift (L) and side (S) force at the front (F) and rear (R) axle centers, where WB is the wheelbase:

LF=L/2+PM/WB

LR=L/2−PM/WB

SF=S/2+YM/WB

SR=S/2−YM/WB

The lift force at each individual wheel may be measured directly:

LLF=−FZLFT

LRF=−FZRFT

LLR=−FZLRT

LRR=−FZRRT

With the freestream dynamic pressure q and the frontal vehicle area A, the aerodynamic coefficients are defined as follows, using the above equations:

CD=D/q/A

CL=L/q/A

CS=S/q/A

CPM=PM/q/A/WB

CYM=YM/q/A/WB

CRM=RM/q/A/WB

CLF=CL/2+CPM

CLR=CL/2−CPM

CSF=CS/2+CYM

CSR=CS/2−CYM

CLLF=LLF/q/A

CLRF=LRF/q/A

CLLR=LLR/q/A

CLRR=LRR/q/A

Reaction forces acting at the VRS attachment points are measured with bi-axial load cells. To determine the forces acting at the tire contact patches, it is necessary to fabricate special wheels for the test vehicle so that a wheel force transducer can be installed between the wheel and the hub. The general concept presented below is applicable to any ground vehicle type, but customized details may be different in each case.

FIG. 1 shows the lateral forces acting on the wheel, tire, hub, and VRS. R_{VRS}_{ᵢ} is the reaction force at the VRS strut, L_{T}_{ᵢ} is the road force acting on the vehicle at the tire contact patch, and F_{H}_{ᵢ} represents all forces transmitted into the hub, such as suspension forces and tire ply steer generated by this tire as well as the other three, and aerodynamic forces.

Two types of wheel force transducers (WFTs) are shown in FIG. 1. In FIG. 1(a), the connection between the VRS hub bearing and the vehicle hub passes through the WFT and creates a load path into its sensing elements. In this case, the WFT measurement, F_{WF}_{ᵢ}, directly senses all three external forces (hub, VRS, and tire contact patch). In FIG. 1(b), this connection passes through the WFT without creating a load path into its sensing elements, which means that the WFT is sensitive only to the force at the tire contact patch. In the absence of the VRS, both WFTs would make the same measurement. The aerodynamic force acting directly on the wheel is not shown for simplicity; this force is part of the overall aerodynamic force acting on the vehicle whose magnitude is to be determined. The method presented here is applicable to different potential vehicle restraint concepts.

Considering FIG. 1(a) first, the force at the tire contact patch can be isolated by considering the wheel as the free body, as demarcated in the Figure. The external forces acting on the wheel must sum to zero:

F_{H}_{ᵢ}+L_{T}_{ᵢ}+R_{VRS}_{ᵢ}=0

The WFT in this case measures the hub force directly. As indicated above, the forces of the vehicle acting on its environment are used in the force summation (i.e., F_{VRS}_{ᵢ}=−R_{VRS}_{ᵢ} and F_{T}_{ᵢ}=L_{T}_{ᵢ}). With these substitutions, the force summation in FIG. 1(a) becomes

F_{WF}_{ᵢ}−F_{T}_{ᵢ}−F_{VRS}_{ᵢ}=0

The force at the tire contact patch is then

F_{T}_{ᵢ}=F_{WF}_{ᵢ}−F_{VRS}_{ᵢ}

In FIG. 1(b), the WFT senses only the tire contact patch force, so the force summation on that free body is

L_{T}_{ᵢ}=−F_{WF}_{ᵢ}=0,

or

L_{T}_{ᵢ}=−F_{WF}_{_{i,}}

so that

F_{T}_{ᵢ}=−L_{T}_{ᵢ}=F_{WF}_{ᵢ}

This equation also applies in the absence of a VRS strut, regardless of the type of WFT employed.

The equations above expressing the force at the tire contact patch for either type of WFT apply equally to forces in the lateral, longitudinal, and vertical directions, so all components of the force vector at the tire contact patch can be resolved. With one of these equations, the final four terms in the net longitudinal and lateral aerodynamic force equations above, and all of the terms in the net vertical aerodynamic force equation above, can be evaluated directly. Suspension forces and internal tire forces such as ply steer and conicity are unknown but do not need to be evaluated because they are internal to the free body diagram.

To allow for either type of WFT, and to account for the presence or absence of a VRS strut on a particular wheel hub, it is helpful to develop a single expression for F_{T}_{ᵢ}. Let Cᵢ=1 if VRS strut load cell i is attached to the vehicle somewhere (but not necessarily to the wheel hub), and 0 if it is not attached at all, i.e., it is not used. (Some setup configurations do not require all four VRS attachments.) Let Tᵢ=1 if VRS strut i is attached to the wheel hub and the WFT is sensitive to both the tire contact patch load and the VRS load, as in FIG. 1(a). (If Tᵢ=0, the strut is attached elsewhere on the vehicle, a cable restraint is used, or the WFT design is such that it is sensitive only to the tire contact patch and not the VRS load.) With these Boolean definitions, the force at the contact patch for tire i is generalized as follows:

F_{T}_{ᵢ}=F_{WF}_{ᵢ}−TᵢCᵢF_{VRS}_{ᵢ}

The net lateral or longitudinal aerodynamic force equations above are now generalized as:

$$\begin{matrix}{F}_{aero} = {\sum }_{i = 1}^{4} [ {C}_{i} {F}_{{VRS}_{i}} + {F}_{{T}_{i}} ] \\ = {\sum }_{i = 1}^{4} [ {C}_{i} {F}_{{VRS}_{i}} + ( {F}_{{WF}_{i}} - {T}_{i} {C}_{i} {F}_{{VRS}_{i}} ) ] \\ {\sum }_{i = 1}^{4} [ {C}_{i} {F}_{{VRS}_{i}} ( 1 - {T}_{i} ) + {F}_{{WF}_{i}} ]\end{matrix}$$

The first term in the equation above represents the first four terms of the net longitudinal and lateral aerodynamic force equations above, while the second term is the generalized force at the tire contact patch, and represents the last four terms in the same equations. If Tᵢ=1 on each wheel that has a VRS strut attached to it (the VRS strut is attached to the wheel as shown in FIG. 1(a)), then

$${F}_{aero} = {\sum }_{i = 1}^{4} {F}_{{WF}_{i}}$$

This result shows that VRS load cells are not required in the test setup if the WFTs are sensitive to both the VRS reaction loads and the tire contact patch loads, as long as the vehicle is restrained only at the wheel hubs.

The wheel force transducer is integrated into the wheel and consequently measures its force components in a wheel (spin) axis coordinate system, whereas the resolution of aerodynamic forces needs to be in the vehicle (body) axis coordinate system of FIG. 4. In one embodiment, this requires a modification to the development leading up to the Fₐₑᵣₒ equations above.

A positive inclination angle, ε, is defined as a rotation about the +X axis in FIG. 4. The top of wheel at positive inclination angle tips to the right when looking upstream. A positive steer angle, δ, is defined as a rotation about the +Z axis in FIG. 2. A wheel with positive steer is turned to the right. Each wheel may have its own inclination and steer angle.

The force components in the vehicle axis of FIG. 4 for wheel i are determined in terms of the measured wheel forces by coordinate rotations first through εᵢ and then through δᵢ:

$$[ \begin{matrix}{F}_{x , {WFB}_{i}} \\ {F}_{y , {WFB}_{i}} \\ {F}_{z , {WFB}_{i}}\end{matrix} ] = [ \begin{matrix}cos {δ}_{i} & - sin {δ}_{i} cos {ɛ}_{i} & sin {δ}_{i} sin {ɛ}_{i} \\ sin {δ}_{i} & cos {δ}_{i} cos {ɛ}_{i} & - cos {δ}_{i} sin {ɛ}_{i} \\ 0 & sin {ɛ}_{i} & cos {ɛ}_{i}\end{matrix} ] [ \begin{matrix}{F}_{x , {WF}_{i}} \\ {F}_{y , {WF}_{i}} \\ {F}_{z , {WF}_{i}}\end{matrix} ]$$

The expressions for lateral or axial wheel force from the above equation may then be used in the equations for net longitudinal or lateral aerodynamic force above to determine the actual longitudinal or lateral aerodynamic forces when either inclination or steer angles are non-zero.

The force measurements and above calculations may be processed by a computing device. In order to provide a context for the computational aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for determining the forces acting on a wheeled vehicle in a wind tunnel, comprising:
one or more wheel force transducers installed between one or more wheels and corresponding hubs on the vehicle.

2. The system of claim 1, further comprising one or more vehicle restraints attached to the vehicle.

3. The system of claim 2, wherein each vehicle restraint further comprises at least one bi-axial load cell.

4. The system of claim 2, wherein one or more of the vehicle restraints comprises a rigid or semi-rigid strut or rod.

5. The system of claim 2, wherein one or more of the vehicle restraints comprises a cable or tie.

6. The system of claim 3, further comprising a computing device with a computer-readable medium, said computer-readable medium including instructions to receive data from the wheel force transducers and bi-axial load cells, and determine the external forces acting on the vehicle at the tire contact patch.

7. A wind-tunnel apparatus for determining aerodynamic forces on a wheeled vehicle, comprising:
a moving ground plane;
a vehicle restraint system for holding the vehicle in place on the moving ground plane;
a wind generator; and
one or more wheel force transducers installed between one or more wheels and corresponding hubs on the vehicle

8. The system of claim 7, wherein the vehicle restraint system comprises one or more vehicle restraints attached to the vehicle.

9. The system of claim 8, wherein each vehicle restraint further comprises at least one bi-axial load cell.

10. The system of claim 8, wherein one or more of the vehicle restraints comprises a rigid or semi-rigid strut or rod.

11. The system of claim 8, wherein one or more of the vehicle restraints comprises a cable or tie.

12. The system of claim 9, further comprising a computing device with a computer-readable medium, said computer-readable medium including instructions to receive data from the wheel force transducers and bi-axial load cells, and determine the external forces acting on the vehicle at the tire contact patch.
